(19) United States
(12) Patent Application Publication
(10) Pub. No.: US 2015/0191576 A1
(43) Pub. Date: Jul. 9, 2015

(54) AZEOTROPIC AND AZEOTROPE-LIKE COMPOSITIONS OF E-1,3,4,4,4-PENTAFLUORO-3-TRIFLUOROMETHYL-1-BUTENE AND Z-1,1,1,4,4,4-HEXAFLUORO-2-BUTENE AND USES THEREOF

(71) Applicant: E I DU PONT DE NEMOURS AND COMPANY, Wilmington, DE (US)

(72) Inventor: Mark L Robin, Middletown, DE (US)

(21) Appl. No.: 14/410,578

(22) PCT Filed: Aug. 1, 2013
(86) PCT No.: PCT/US2013/053175

§ 371 Date: Dec. 23, 2014

Related U.S. Application Data
(60) Provisional application No. 61/678,260, filed on Aug. 1, 2012.
(60) Provisional application No. 61/678,257, filed on Aug. 1, 2012.

(51) Int. Cl. C08J 9/14; C09K 3/00; A62C 13/62; H01B 3/24; C09K 3/30; C09K 5/04; A62D 1/00

(52) U.S. Cl. CPC C08J 9/146; C09K 5/045; C09K 3/00; A62D 1/0057; H01B 3/24; C09K 3/30; A62C 13/62; C09K 2205/24; C09K 2205/22; C09K 2205/12; C09K 2205/32; C08J 2203/18; C08J 2300/22; C08J 2300/24

(57) ABSTRACT

Azeotropic or azeotrope-like compositions are disclosed. The azeotropic or azeotrope-like compositions are mixtures of E-1,3,4,4,4-pentafluoro-3-trifluoromethyl-1-butene and Z-1,1,1,4,4,4-hexafluoro-2-butene. Also disclosed is a process of preparing a thermoplastic or thermoset foam by using such azeotropic or azeotrope-like compositions as blowing agents. Also disclosed is a process of producing refrigeration by using such azeotropic or azeotrope-like compositions. Also disclosed is a process of using such azeotropic or azeotrope-like compositions as solvents. Also disclosed is a process of producing an aerosol product by using such azeotropic or azeotrope-like compositions. Also disclosed is a process of using such azeotropic or azeotrope-like compositions as heat transfer media. Also disclosed is a process of extinguishing or suppressing a fire by using such azeotropic or azeotrope-like compositions. Also disclosed is a process of using such azeotropic or azeotrope-like compositions as dielectrics.

### CROSS REFERENCE TO RELATED APPLICATIONS

This application claims the benefit of priority of U.S. Provisional Application 61/678,260, filed Aug. 1, 2012, and incorporated herein by reference. This application also claims benefit of priority of U.S. Provisional Application 61/678,257, filed Aug. 1, 2012, titled “Azeotropic and Azeotrope-Like Compositions of E-1,3,4,4,4-Pentafluoro-3-Trifluoromethyl-1-Butene and Cyclopentane and Uses Thereof”, also incorporated herein by reference.

### FIELD OF THE DISCLOSURE

The present disclosure relates to azeotropic and azeotrope-like compositions of E-1,3,4,4,4-pentafluoro-3-trifluoromethyl-1-butene and Z-1,1,1,4,4,4-hexafluoro-2-butene.

### DESCRIPTION OF RELATED ART

Many industries have been working for the past few decades to find replacements for the ozone depleting chlorofluorocarbons (CFCs) and hydrochlorofluorocarbons (HCFCs). The CFCs and HCFCs have been employed in a wide range of applications, including their use as aerosol propellants, refrigerants, cleaning agents, expansion agents for thermoplastic and thermoset foams, heat transfer media, gaseous dielectrics, fire extinguishing and suppression agents, power cycle working fluids, polymerization media, particulate removal fluids, carrier fluids, buffing abrasive agents, and displacement drying agents. In the search for replacements for these versatile compounds, many industries have turned to the use of hydrofluorocarbons (HFCs).

The HFCs do not contribute to the destruction of stratospheric ozone, but are of concern due to their contribution to the “greenhouse effect”, i.e., they contribute to global warming. As a result of their contribution to global warming, the HFCs have come under scrutiny, and their widespread use may also be limited in the future. Thus, there is a need for compositions that do not contribute to the destruction of stratospheric ozone and also have low global warming potentials (GWPs).

### SUMMARY OF THE INVENTION

This disclosure provides a composition consisting essentially of (a) E-HFO-1438ezy and a second component present in an effective amount to form an azeotrope or azeotrope like mixture. In one embodiment the disclosure, the second component includes Z-HFO-1336mzz or cyclopentane.

### BRIEF SUMMARY OF THE DRAWINGS

FIG. 1—FIG. 1 is a graphical representation of an azeotropic composition of E-HFO-1438ezy and Z-HFO-1336mzz at a temperature of about 25° C.

FIG. 2—FIG. 2 is a graphical representation of an azeotropic composition of E-HFO-1438ezy and cyclopentane at a temperature of about 25.0° C.

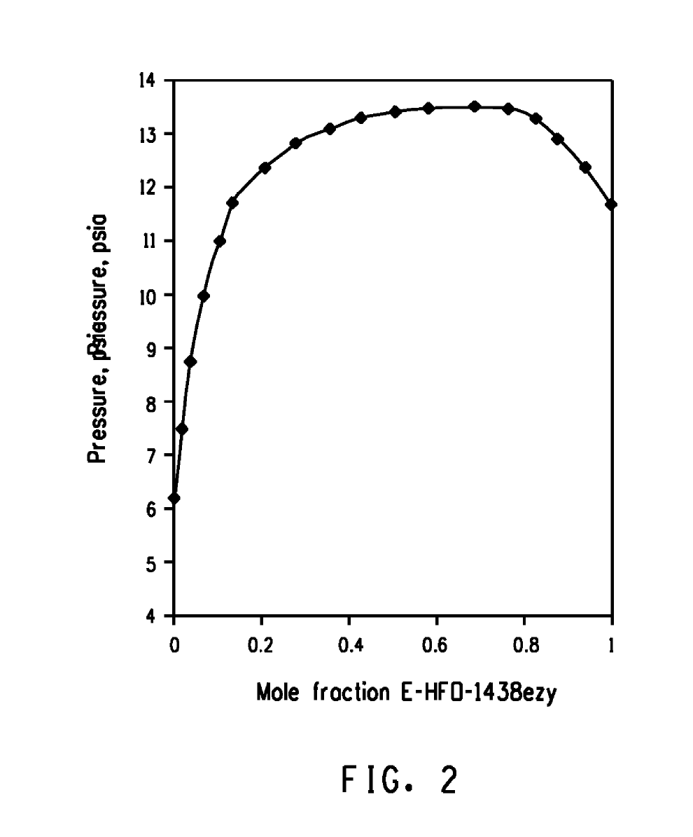

### DETAILED DESCRIPTION OF THE INVENTION

It was found that 1,3,4,4,4-pentafluoro-3-trifluoromethyl-1-butene (HFO-1438ezy, (CF₃)₂CFCH═CHF), 1,1,1,4,4,4-hexafluoro-2-butene (CF₃CH═CHCF₃, HFO-1336mzz) and cyclopentane do not contribute to the destruction of stratospheric ozone and also have low global warming potentials (GWPs).

In many applications, the use of a pure single component or an azeotropic or azeotrope-like mixture is desirable. For example, when a blowing agent composition (also known as foam expansion agents or foam expansion compositions) is not a pure single component or an azeotropic or azeotrope-like mixture, the composition may change during its application in the foam forming process. Such change in composition could detrimentally affect processing or cause poor performance in the application. Also, in refrigeration applications, a refrigerant is often lost during operation through leaks in shaft seals, hose connections, soldered joints and broken lines. In addition, the refrigerant may be released to the atmosphere during maintenance procedures on refrigeration equipment. If the refrigerant is not a pure single component or an azeotropic or azeotrope-like composition, the refrigerant composition may change when leaked or discharged to the atmosphere from the refrigeration equipment. The change in refrigerant composition may cause the refrigerant to become flammable or to have poor refrigeration performance. Accordingly, there is a need for using azeotropic or azeotrope-like mixtures in these and other applications, for example azeotropic or azeotrope-like mixtures containing E-1,3,4,4,4-pentafluoro-3-trifluoromethyl-1-butene (trans-1,3,4,4,4-pentafluoro-3-trifluoromethyl-1-butene, E-HFO-1438ezy, trans-HFO-1438ezy, E-(CF₃)₂CFCH═CHF, trans-(CF₃)₂CFCH═CHF) and at least one other component, where preferably, the second component also does not harm the environment relative to incumbent products. Preferably, the second component is Z-1,1,1,4,4,4-hexafluoro-2-butene (cis-1,1,1,4,4,4-hexafluoro-2-butene, Z-CF₃CH═CHCF₃, cis-CF₃CH═CHCF₃, Z-HFO-1336mzz, cis-HFO-1336mzz) or cyclopentane.

Before addressing details of embodiments described below, some terms are defined or clarified.

HFO-1438ezy may exist as one of two configurational isomers, E or Z. HFO-1438ezy as used herein refers to the isomers, Z-HFO-1438ezy or E-HFO-1438ezy, as well as any combinations or mixtures of such isomers.

HFO-1336mzz may exist as one of two configurational isomers, E or Z. HFO-1336mzz as used herein refers to the isomers, Z-HFO-1336mzz or E-HFO-1336mzz, as well as any combinations or mixtures of such isomers.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. In case of conflict, the present specification, including definitions, will control. Although methods and materials similar or equivalent to those described herein can be used in the practice or testing of embodiments of the present invention, suitable methods and materials are described below. In addition, the materials, methods, and examples are illustrative only and not intended to be limiting.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

HFO-1438ezy is a known compound, and can be made through a catalytic addition reaction between (CF₃)₂CFI and CH₂═CHF, followed by an elimination reaction to remove HI, such as disclosed in U.S. Pat. No. 8,148,584.

Z-HFO-1336mzz is a known compound, and can be made by the selective hydrogenation of hexafluoro-2-butyne with a Lindlar catalyst and hydrogen, such as disclosed in U.S. Patent Publication No. 2008-0269532.

This application includes compositions consisting essentially of (a) E-HFO-1438ezy and (b) Z-HFO-1336mzz; wherein the Z-HFO-1336mzz is present in an effective amount to form an azeotropic or azeotrope-like mixture with E-HFO-1438ezy.

By effective amount is meant an amount of Z-HFO-1336mzz, which, when combined with E-HFO-1438ezy, results in the formation of an azeotropic or azeotrope-like mixture.

By effective amount is meant an amount of cyclopentane, which, when combined with E-HFO-1438ezy, results in the formation of an azeotropic or azeotrope-like mixture.

This definition includes the amounts of each component, which amounts may vary depending on the pressure applied to the composition so long as the azeotropic or azeotrope-like compositions continue to exist at the different pressures, but with possible different boiling points. Therefore, effective amount includes the amounts, such as may be expressed in weight or mole percentages, of each component of the compositions of the instant invention which form azeotropic or azeotrope-like compositions at temperatures or pressures other than as described herein.

As recognized in the art, an azeotropic composition is an admixture of two or more different components which, when in liquid form under a given pressure, will boil at a substantially constant temperature, which temperature may be higher or lower than the boiling temperatures of the individual components, and which will provide a vapor composition essentially identical to the overall liquid composition undergoing boiling. (see, e.g., M. F. Doherty and M. F. Malone, Conceptual Design of Distillation Systems, McGraw-Hill (New York), 2001, 185-186, 351-359).

Accordingly, the essential features of an azeotropic composition are that at a given pressure, the boiling point of the liquid composition is fixed and that the composition of the vapor above the boiling composition is essentially that of the overall boiling liquid composition (i.e., no fractionation of the components of the liquid composition takes place). It is also recognized in the art that both the boiling point and the weight percentages of each component of the azeotropic composition may change when the azeotropic composition is subjected to boiling at different pressures. Thus, an azeotropic composition may be defined in terms of the unique relationship that exists among the components or in terms of the compositional ranges of the components or in terms of exact weight percentages of each component of the composition characterized by a fixed boiling point at a specified pressure.

For the purpose of this invention, an azeotrope-like composition means a composition that behaves like an azeotropic composition (i.e., has constant boiling characteristics or a tendency not to fractionate upon boiling or evaporation). Hence, during boiling or evaporation, the vapor and liquid compositions, if they change at all, change only to a minimal or negligible extent. This is to be contrasted with non-azeotrope-like compositions in which during boiling or evaporation, the vapor and liquid compositions change to a substantial degree.

Additionally, azeotrope-like compositions exhibit dew point pressure and bubble point pressure with virtually no pressure differential. That is to say that the difference in the dew point pressure and bubble point pressure at a given temperature will be a small value. In this invention, compositions with a difference in dew point pressure and bubble point pressure of less than or equal to 5 percent (based upon the bubble point pressure) is considered to be azeotrope-like.

It is recognized in this field that when the relative volatility of a system approaches 1.0, the system is defined as forming an azeotropic or azeotrope-like composition. Relative volatility is the ratio of the volatility of component 1 to the volatility of component 2. The ratio of the mole fraction of a component in vapor to that in liquid is the volatility of the component.

To determine the relative volatility of any two compounds, a method known as the PTx method can be used. The vapor-liquid equilibrium (VLE), and hence relative volatility, can be determined either isothermally or isobarically. The isothermal method requires measurement of the total pressure of mixtures of known composition at constant temperature. In this procedure, the total absolute pressure in a cell of known volume is measured at a constant temperature for various compositions of the two compounds. The isobaric method requires measurement of the temperature of mixtures of known composition at constant pressure. In this procedure, the temperature in a cell of known volume is measured at a constant pressure for various compositions of the two compounds. Use of the PTx Method is described in detail in “Phase Equilibrium in Process Design”, Wiley-Interscience Publisher, 1970, written by Harold R. Null, on pages 124 to 126.

These measurements can be converted into equilibrium vapor and liquid compositions in the PTx cell by using an activity coefficient equation model, such as the Non-Random, Two-Liquid (NRTL) equation, to represent liquid phase nonidealities. Use of an activity coefficient equation, such as the NRTL equation is described in detail in “The Properties of Gases and Liquids,” 4th edition, published by McGraw Hill, written by Reid, Prausnitz and Poling, on pages 241 to 387, and in “Phase Equilibria in Chemical Engineering,” published by Butterworth Publishers, 1985, written by Stanley M. Walas, pages 165 to 244. Without wishing to be bound by any theory or explanation, it is believed that the NRTL equation, together with the PTx cell data, can sufficiently predict the relative volatilities of the E-HFO-1438ezy/Z-HFO-1336mzz compositions of the present invention and can therefore predict the behavior of these mixtures in multi-stage separation equipment such as distillation columns.

It was found through experiments that E-HFO-1438ezy and Z-HFO-1336mzz form azeotropic or azeotrope-like compositions.

To determine the relative volatility of this binary pair, the PTx method described above was used. The pressure in a PTx cell of known volume was measured at constant temperature for various binary compositions. These measurements were then reduced to equilibrium vapor and liquid compositions in the cell using the NRTL equation.

### EXAMPLE 1

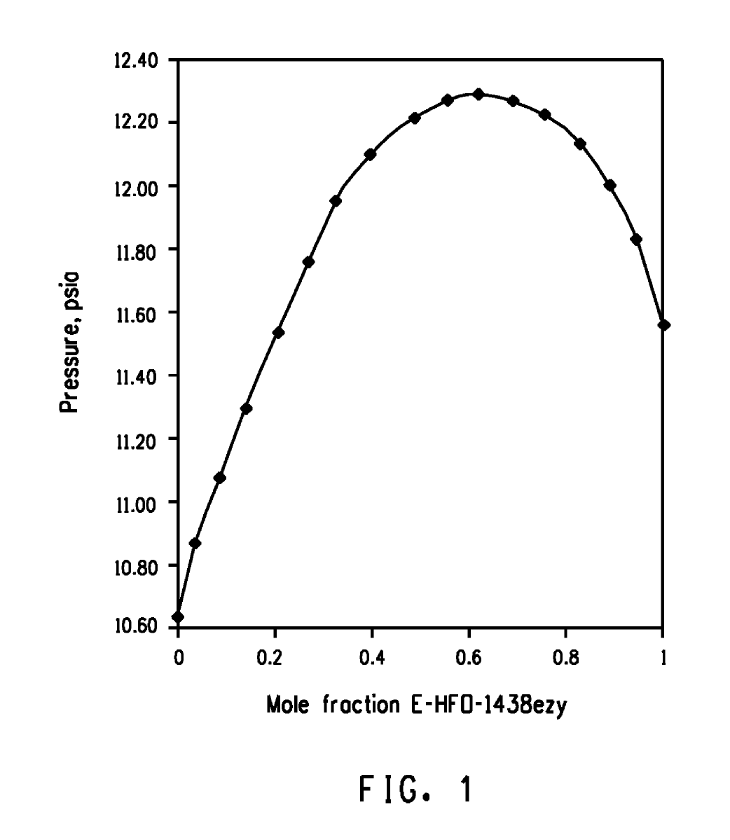

The pressures measured versus the compositions in the PTx cell for E-HFO-1438ezy/Z-HFO-1336mzz mixtures are shown in FIG. 1, which graphically illustrates the formation of an azeotropic composition consisting essentially of E-HFO-1438ezy and Z-HFO-1336mzz as indicated by a mixture of about 63.7 mole % E-HFO-1438ezy and about 36.3 mole % Z-HFO-1336mzz having the highest pressure over the range of compositions at about 25° C. Based upon these findings, it has been calculated that E-HFO-1438ezy and Z-HFO-1336mzz form azeotropic compositions ranging from about 64.0 mole percent to about 61.3 mole percent E-HFO-1438ezy and from about 36.0 mole percent to about 38.7 mole percent Z-HFO-1336mzz (which form azeotropic compositions boiling at a temperature of from about −50° C. to about 140° C. and at a pressure of from about 0.2 psia (1.4 kPa) to about 261 psia (1799 kPa)). For example, at about 25° C. and about 12.4 psia (85 kPa) the azeotropic composition consists essentially of about 63.7 mole % E-HFO-1438ezy and about 36.3 mole % Z-HFO-1336mzz. For another example, at about 29.5° C. and about atmospheric pressure (14.7 psia, 101 kPa) the azeotropic composition consists essentially of about 63.8 mole % E-HFO-1438ezy and about 36.2 mole % Z-HFO-1336mzz. Some embodiments of azeotropic compositions are listed in Table 1.

TABLE 1
Azeotropic compositions

| Azeotropic | Azeotropic | | |
|---|---|---|---|
| Temperature | Pressure | E-HFO-1438ezy | Z-HFO-1336mzz |
| (° C.) | (psia) | (mole %) | (mole %) |
| −50 | 0.2 | 61.3 | 38.7 |
| −40 | 0.4 | 61.8 | 38.2 |
| −30 | 0.8 | 62.2 | 37.8 |
| −20 | 1.5 | 62.6 | 37.4 |
| −10 | 2.6 | 62.9 | 37.1 |
| 0 | 4.3 | 63.2 | 36.8 |
| 10 | 6.7 | 63.4 | 36.6 |
| 20 | 10.2 | 63.7 | 36.3 |
| 25 | 12.4 | 63.7 | 36.3 |
| 30 | 15.0 | 63.8 | 36.2 |
| 40 | 21.3 | 63.9 | 36.1 |
| 50 | 29.5 | 64.0 | 36.0 |
| 60 | 40.0 | 64.0 | 36.0 |
| 70 | 53.2 | 64.0 | 36.0 |
| 80 | 69.4 | 64.0 | 36.0 |
| 90 | 89.1 | 63.9 | 36.1 |
| 100 | 112.8 | 63.8 | 36.2 |
| 110 | 141.1 | 63.7 | 36.3 |
| 120 | 174.6 | 63.5 | 36.5 |
| 130 | 214.1 | 63.3 | 36.7 |
| 140 | 260.7 | 63.0 | 37.0 |

Additionally, azeotrope-like compositions containing E-HFO-1438ezy and Z-HFO-1336mzz may also be formed. In some embodiments of this invention, an azeotrope-like composition consists essentially of 1-99 mole % E-HFO-1438ezy and 99-1 mole % Z-HFO-1336mzz at a temperature ranging from about −40° C. to about 140° C. (i.e., over this temperature range, the difference in dew point pressure and bubble point pressure of the composition at a particular temperature is less than or equal to 5 percent (based upon the bubble point pressure)). In some embodiments of this invention, an azeotrope-like composition consists essentially of 5-95 mole % E-HFO-1438ezy and 95-5 mole % Z-HFO-1336mzz at a temperature ranging from about −40° C. to about 140° C. (i.e., over this temperature range, the difference in dew point pressure and bubble point pressure of the composition at a particular temperature is less than or equal to 5 percent (based upon the bubble point pressure)).

Such azeotrope-like compositions exist around azeotropic compositions. Some embodiments of azeotrope-like compositions are listed in Table 2. Additional embodiments of azeotrope-like compositions are listed in Table 3.

TABLE 2
Azeotrope-like compositions

| | | Mole Percentage |
|---|---|---|
| COMPONENTS | T (° C.) | Range |
| E-HFO-1438ezy/Z-HFO-1336mzz | −40 | 1-99/1-99 |
| E-HFO-1438ezy/Z-HFO-1336mzz | −20 | 1-99/1-99 |
| E-HFO-1438ezy/Z-HFO-1336mzz | 0 | 1-99/1-99 |
| E-HFO-1438ezy/Z-HFO-1336mzz | 40 | 1-99/1-99 |
| E-HFO-1438ezy/Z-HFO-1336mzz | 80 | 1-99/1-99 |
| E-HFO-1438ezy/Z-HFO-1336mzz | 120 | 1-99/1-99 |
| E-HFO-1438ezy/Z-HFO-1336mzz | 140 | 1-99/1-99 |

TABLE 3
Azeotrope-like compositions

| | | Mole Percentage |
|---|---|---|
| COMPONENTS | T (° C.) | Range |
| E-HFO-1438ezy/Z-HFO-1336mzz | −40 | 5-95/5-95 |
| E-HFO-1438ezy/Z-HFO-1336mzz | −20 | 5-95/5-95 |
| E-HFO-1438ezy/Z-HFO-1336mzz | 0 | 5-95/5-95 |
| E-HFO-1438ezy/Z-HFO-1336mzz | 40 | 5-95/5-95 |
| E-HFO-1438ezy/Z-HFO-1336mzz | 80 | 5-95/5-95 |
| E-HFO-1438ezy/Z-HFO-1336mzz | 120 | 5-95/5-95 |
| E-HFO-1438ezy/Z-HFO-1336mzz | 140 | 5-95/5-95 |

The azeotropic or azeotrope-like compositions of the present invention can be prepared by any convenient method including mixing or combining the desired amounts. In one embodiment of this invention, an azeotropic or azeotrope-like composition can be prepared by weighing the desired component amounts and thereafter combining them in an appropriate container.

The azeotropic or azeotrope-like compositions of the present invention can be used in a wide range of applications, including their use as aerosol propellants, refrigerants, solvents, cleaning agents, blowing agents (foam expansion agents) for thermoplastic and thermoset foams, heat transfer media, gaseous dielectrics, fire extinguishing and suppression agents, power cycle working fluids, polymerization media, particulate removal fluids, carrier fluids, buffing abrasive agents, and displacement drying agents.

One embodiment of this invention provides a process for preparing a thermoplastic or thermoset foam. The process comprises using an azeotropic or azeotrope-like composition as a blowing agent, wherein said azeotropic or azeotrope-like composition consists essentially of E-HFO-1438ezy and Z-HFO-1336mzz. For thermoplastic foams, this process includes mixing the blowing agent with a liquid resin under elevated temperatures and pressures, and extruding the resin to form the foam. For thermoset foams, this process includes mixing the blowing agent with a polyol, and mixing the polyol with an isocyanate to form the foam

Another embodiment of this invention provides a process for producing refrigeration. The process comprises condensing an azeotropic or azeotrope-like composition and thereafter evaporating said azeotropic or azeotrope-like composition in the vicinity of the body to be cooled, wherein said azeotropic or azeotrope-like composition consists essentially of E-HFO-1438ezy and Z-HFO-1336mzz.

Another embodiment of this invention provides a process using an azeotropic or azeotrope-like composition as a solvent, wherein said azeotropic or azeotrope-like composition consists essentially of E-HFO-1438ezy and Z-HFO-1336mzz. This process includes the step of contacting the composition to a surface to be cleaned and then removing the composition or removing the surface.

Another embodiment of this invention provides a process for producing an aerosol product. The process comprises using an azeotropic or azeotrope-like composition as a propellant, wherein said azeotropic or azeotrope-like composition consists essentially of E-HFO-1438ezy and Z-HFO-1336mzz.

Another embodiment of this invention provides a process using an azeotropic or azeotrope-like composition as a heat transfer media, wherein said azeotropic or azeotrope-like composition consists essentially of E-HFO-1438ezy and Z-HFO-1336mzz.

Another embodiment of this invention provides a process for extinguishing or suppressing a fire. The process comprises using an azeotropic or azeotrope-like composition as a fire extinguishing or suppression agent, wherein said azeotropic or azeotrope-like composition consists essentially of E-HFO-1438ezy and Z-HFO-1336mzz. The process includes detecting a fire or incipient ignition, and delivering a sufficient amount of the composition to the fire or incipient ignition to reach an extinguishing concentration that suppresses or extinguishes the fire.

Another embodiment of this invention provides a process using an azeotropic or azeotrope-like composition as dielectrics, wherein said azeotropic or azeotrope-like composition consists essentially of E-HFO-1438ezy and Z-HFO-1336mzz.

### EXAMPLE 2

The pressures measured versus the compositions in the PTx cell for E-HFO-1438ezy/cyclopentane mixtures are shown in FIG. 1, which graphically illustrates the formation of an azeotropic composition consisting essentially of E-HFO-1438ezy and cyclopentane as indicated by a mixture of about 67.7 mole % E-HFO-1438ezy and about 32.3 mole % cyclopentane having the highest pressure over the range of compositions at about 25.0° C. Based upon these findings, it has been calculated that E-HFO-1438ezy and cyclopentane form azeotropic compositions ranging from about 66.8 mole percent to about 95.2 mole percent E-HFO-1438ezy and from about 33.2 mole percent to about 4.8 mole percent cyclopentane (which form azeotropic compositions boiling at a temperature of from about −50° C. to about 140° C. and at a pressure of from about 0.2 psia (1.4 kPa) to about 250 psia (1724 kPa)). For example, at about 25.0° C. and about 13.5 psia (93 kPa) the azeotropic composition consists essentially of about 67.7 mole % E-HFO-1438ezy and about 32.3 mole % cyclopentane. For another example, at about 27.3° C. and about atmospheric pressure (14.7 psia, 101 kPa) the azeotropic composition consists essentially of about 67.9 mole % E-HFO-1438ezy and about 32.1 mole % cyclopentane. Some embodiments of azeotropic compositions are listed in Table 1.

TABLE 1
Azeotropic compositions

| Azeotropic | Azeotropic | | |
|---|---|---|---|
| Temperature | Pressure | E-HFO-1438ezy | Cyclopentane |
| (° C.) | (psia) | (mole %) | (mole %) |
| −50 | 0.2 | 67.2 | 32.8 |
| −40 | 0.5 | 67.0 | 33.0 |
| −30 | 1.0 | 66.9 | 33.1 |
| −20 | 1.7 | 66.8 | 33.2 |
| −10 | 3.0 | 66.9 | 33.1 |
| 0 | 4.8 | 67.0 | 33.0 |
| 10 | 7.5 | 67.2 | 32.8 |
| 20 | 11.2 | 67.5 | 32.5 |
| 25 | 13.5 | 67.7 | 32.3 |
| 30 | 16.2 | 68.0 | 32.0 |
| 40 | 22.8 | 68.5 | 31.5 |
| 50 | 31.2 | 69.2 | 30.8 |
| 60 | 41.9 | 70.1 | 29.9 |
| 70 | 55.0 | 71.2 | 28.8 |
| 80 | 70.9 | 72.6 | 27.4 |
| 90 | 90.0 | 74.3 | 25.7 |
| 100 | 112.7 | 76.4 | 23.6 |
| 110 | 139.3 | 79.2 | 20.8 |
| 120 | 170.5 | 82.8 | 17.2 |
| 130 | 206.8 | 87.8 | 12.2 |
| 140 | 249.5 | 95.2 | 4.8 |

Additionally, azeotrope-like compositions containing E-HFO-1438ezy and cyclopentane may also be formed. In some embodiments of this invention, an azeotrope-like composition consists essentially of 99-48 mole % E-HFO-1438ezy and 1-52 mole % cyclopentane at a temperature ranging from about −40° C. to about 140° C. (i.e., over this temperature range, the difference in dew point pressure and bubble point pressure of the composition at a particular temperature is less than or equal to 5 percent (based upon the bubble point pressure)). In some embodiments of this invention, an azeotrope-like composition consists essentially of 1-4 mole % E-HFO-1438ezy and 99-96 mole % cyclopentane at a temperature ranging from about 120° C. to about 140° C. (i.e., over this temperature range, the difference in dew point pressure and bubble point pressure of the composition at a particular temperature is less than or equal to 5 percent (based upon the bubble point pressure)). In some embodiments of this invention, an azeotrope-like composition consists essentially of 48-95 mole % E-HFO-1438ezy and 52-5 mole % cyclopentane at a temperature ranging from about −40° C. to about 140° C. (i.e., over this temperature range, the difference in dew point pressure and bubble point pressure of the composition at a particular temperature is less than or equal to 5 percent (based upon the bubble point pressure)).

Such azeotrope-like compositions exist around azeotropic compositions. Some embodiments of azeotrope-like compositions are listed in Table 2. Additional embodiments of azeotrope-like compositions are listed in Table 3.

TABLE 2
Azeotrope-like compositions

| | | Mole Percentage |
|---|---|---|
| COMPONENTS | T (° C.) | Range |
| E-HFO-1438ezy/Cyclopentane | −40 | 60-77/40-23 |
| E-HFO-1438ezy/Cyclopentane | −20 | 98-99/2-1 and |
| | | 60-79/40-21 |
| E-HFO-1438ezy/Cyclopentane | 0 | 95-99/5-1 and |
| | | 59-83/41-17 |
| E-HFO-1438ezy/Cyclopentane | 20 | 58-99/42-1 |
| E-HFO-1438ezy/Cyclopentane | 40 | 56-99/44-1 |
| E-HFO-1438ezy/Cyclopentane | 60 | 55-99/45-1 |
| E-HFO-1438ezy/Cyclopentane | 80 | 54-99/46-1 |
| E-HFO-1438ezy/Cyclopentane | 100 | 52-99/48-1 |
| E-HFO-1438ezy/Cyclopentane | 120 | 51-99/49-1 and |
| | | 1-2/99-98 |
| E-HFO-1438ezy/Cyclopentane | 140 | 48-99/52-1 and |
| | | 1-4/99-96 |

TABLE 3
Azeotrope-like compositions

| | | Mole Percentage |
|---|---|---|
| COMPONENTS | T (° C.) | Range |
| E-HFO-1438ezy/Cyclopentane | −40 | 61-74/39-26 |
| E-HFO-1438ezy/Cyclopentane | −20 | 61-75/39-25 |
| E-HFO-1438ezy/Cyclopentane | 0 | 60-78/40-22 |
| E-HFO-1438ezy/Cyclopentane | 20 | 60-82/40-18 |
| E-HFO-1438ezy/Cyclopentane | 40 | 56-95/44-5 |
| E-HFO-1438ezy/Cyclopentane | 60 | 55-95/45-5 |
| E-HFO-1438ezy/Cyclopentane | 80 | 54-95/46-5 |
| E-HFO-1438ezy/Cyclopentane | 100 | 52-95/48-5 |
| E-HFO-1438ezy/Cyclopentane | 120 | 51-95/49-5 |
| E-HFO-1438ezy/Cyclopentane | 140 | 48-95/52-5 |

The azeotropic or azeotrope-like compositions of the present invention can be prepared by any convenient method including mixing or combining the desired amounts. In one embodiment of this invention, an azeotropic or azeotrope-like composition can be prepared by weighing the desired component amounts and thereafter combining them in an appropriate container.

The azeotropic or azeotrope-like compositions of the present invention can be used in a wide range of applications, including their use as aerosol propellants, refrigerants, solvents, cleaning agents, blowing agents (foam expansion agents) for thermoplastic and thermoset foams, heat transfer media, gaseous dielectrics, fire extinguishing and suppression agents, power cycle working fluids, polymerization media, particulate removal fluids, carrier fluids, buffing abrasive agents, and displacement drying agents.

One embodiment of this invention provides a process for preparing a thermoplastic or thermoset foam. The process comprises using an azeotropic or azeotrope-like composition as a blowing agent, wherein said azeotropic or azeotrope-like composition consists essentially of E-HFO-1438ezy and cyclopentane. For thermoplastic foams, this process includes mixing the blowing agent with a liquid resin under elevated temperatures and pressures, and extruding the resin to form the foam. For thermoset foams, this process includes mixing the blowing agent with a polyol, and mixing the polyol with an isocyanate to form the foam

Another embodiment of this invention provides a process for producing refrigeration. The process comprises condensing an azeotropic or azeotrope-like composition and thereafter evaporating said azeotropic or azeotrope-like composition in the vicinity of the body to be cooled, wherein said azeotropic or azeotrope-like composition consists essentially of E-HFO-1438ezy and cyclopentane.

Another embodiment of this invention provides a process using an azeotropic or azeotrope-like composition as a solvent, wherein said azeotropic or azeotrope-like composition consists essentially of E-HFO-1438ezy and cyclopentane. This process includes the step of contacting the composition to a surface to be cleaned and then removing the composition or removing the surface.

Another embodiment of this invention provides a process for producing an aerosol product. The process comprises using an azeotropic or azeotrope-like composition as a propellant, wherein said azeotropic or azeotrope-like composition consists essentially of E-HFO-1438ezy and cyclopentane.

Another embodiment of this invention provides a process using an azeotropic or azeotrope-like composition as a heat transfer media, wherein said azeotropic or azeotrope-like composition consists essentially of E-HFO-1438ezy and cyclopentane.

Another embodiment of this invention provides a process for extinguishing or suppressing a fire. The process comprises using an azeotropic or azeotrope-like composition as a fire extinguishing or suppression agent, wherein said azeotropic or azeotrope-like composition consists essentially of E-HFO-1438ezy and cyclopentane.

Another embodiment of this invention provides a process using an azeotropic or azeotrope-like composition as dielectrics, wherein said azeotropic or azeotrope-like composition consists essentially of E-HFO-1438ezy and cyclopentane.

1. A composition consisting essentially of:
E-1,3,4,4,4-pentafluoro-3-trifluoromethyl-1-butene and a second component, wherein the second component is Z-1,1,1,4,4,4-hexafluoro-2-butene or cyclopentane and wherein the second component is present in an effective amount to form an azeotropic combination with the E-1,3,4,4,4-pentafluoro-3-trifluoromethyl-1-butene.

2. A composition consisting essentially of:
E-1,3,4,4,4-pentafluoro-3-trifluoromethyl-1-butene and a second component, wherein the second component is Z-1,1,1,4,4,4-hexafluoro-2-butene or cyclopentane, and
wherein the second component is present in an effective amount to form an azeotrope-like combination with the E-1,3,4,4,4-pentafluoro-3-trifluoromethyl-1-butene.

3. A process for preparing a thermoplastic or thermoset foam comprising mixing the azeotropic composition of claim 1 with a with a polyol or a resin.

4. A process for preparing a thermoplastic or thermoset foam comprising mixing the azeotrope-like composition of claim 2 with a polyol or resin.

5. A process for producing refrigeration comprising condensing the azeotropic composition of claim 1 and thereafter evaporating said azeotropic composition in the vicinity of the body to be cooled.

6. A process for producing refrigeration comprising condensing the azeotrope-like composition of claim 2 and thereafter evaporating said azeotrope-like composition in the vicinity of the body to be cooled.

7. A process comprising using the azeotropic composition of claim 1 as a solvent.

8. A process comprising using the azeotrope-like composition of claim 2 as a solvent.

9. A process for producing an aerosol product comprising using the azeotropic composition of claim 1 as a propellant.

10. A process for producing an aerosol product comprising using the azeotrope-like composition of claim 2 as a propellant.

11. A process comprising using the azeotropic composition of claim 1 as a heat transfer media.

12. A process comprising using the azeotrope-like composition of claim 2 as a heat transfer media.

13. A process for extinguishing or suppressing a fire comprising using the azeotropic composition of claim 1 as a fire extinguishing or suppression agent.

14. A process for extinguishing or suppressing a fire comprising using the azeotrope-like composition of claim 2 as a fire extinguishing or suppression agent.

15. A process comprising using the azeotropic composition of claim 1 as dielectrics.

16. A process comprising using the azeotrope-like composition of claim 2 as dielectrics.
